(19) United States
(12) Patent Application Publication
(10) Pub. No.: US 2012/0227091 A1
(43) Pub. Date: Sep. 6, 2012

(54) POLYMORPHIC ASSURED NETWORK

(75) Inventor: Fred Hewitt Smith, Old Town, ME (US)

(73) Assignee: ANGEL SECURE NETWORKS, INC., Orono, ME (US)

(21) Appl. No.: 13/410,257

(22) Filed: Mar. 1, 2012

Related U.S. Application Data
(60) Provisional application No. 61/447,777, filed on Mar. 1, 2011.

(51) Int. Cl. G06F 21/00; G06F 15/173

(52) U.S. Cl. 726/4; 709/238

(57) ABSTRACT

Described herein are devices and techniques for implementing a polymorphic network adapted to change network path configurations among a number of pre-determined network path configurations in response to a perceived threat. Such perceived threats can include detection of an unknown process, or simply according to some schedule, or randomly to prevent or otherwise reduce susceptibility to such perceived threats. Multiple (e.g., redundant) network communications paths can be pre-configured between two endpoints. Network communications between the two endpoints can be periodically redirected, for example, in response to a perceived threat or according to one or more rules and/or a schedule to otherwise avoid a perceived threat. A system adapted to permit such pre-configuration of multiple network paths can include an access restrictor in communication with a network configuration controller to prohibit unauthorized pre-configuration of the network paths.

### RELATED APPLICATIONS

This application claims priority to U.S. Provisional Patent Application No. 61/447,777, filed on Mar. 1, 2011. The entire teachings of the provisional application are incorporated herein by reference.

### TECHNICAL FIELD

This application relates generally to the field of network communications. More particularly, this application relates to the technology of secure network communications.

### BACKGROUND

Network communications can be established between two or more entities. It is understood that such network communications can be used to share information between such entities and/or to distribute processing of information among the entities. Many applications require a measure of security in any such networked undertaking. Such measure of security can guard against one or more of interception of sensitive information and malicious or even unintended threats to exposure and/or corruption of such sensitive information.

Some solutions rely on establishing control over the underlying network infrastructure, for example, ensuring or otherwise guarding against unauthorized access to network resources. Unfortunately, such systems can be limited by the availability of such controlled assets, in addition to the additional cost of establishing and maintaining such infrastructure. Alternatively or in addition, some solutions rely on establishing a measure of encryption of data passed along such a network that might otherwise be unprotected. Once again, implementation of such a security scheme generally requires pre-coordination and can be susceptible to attack or undermining by unwanted introduction of malicious processes, such as key capture processes adapted to detect passwords or other sensitive information.

### SUMMARY

Described herein are systems and techniques for implementing a polymorphic network adapted change network path configurations among a number of pre-determined network path configurations in response to a perceived threat. Such perceived threats can include detection of an unknown process, or simply according to some schedule, or randomly to prevent or otherwise reduce such perceived threats.

In one aspect, at least one embodiment described herein provides a process for networked communications including pre-configuring a network communications path between two endpoints. The network communications path is suitable for communications between the two endpoints. At least one different network communications path is also pre-configured between the two endpoints. Each of the at least one different network communication paths is suitable for communications between the two endpoints. The process includes periodically redirecting communications between the two endpoints from one of the network communications path and the at least one different network communications path to another of the network communications path and the at least one different network communications path.

In another aspect, at least one embodiment described herein provides a system for network control, including a network pre-configuration controller in communication with a communications network. The system is adapted to permit pre-configuration of multiple network paths between at least two endpoints. The system is also includes an access restrictor in communication with the network configuration controller and adapted to prohibit unauthorized pre-configuration of the plurality of network paths. An electronically accessible memory is included in communication with the network configuration controller and adapted for storing the multiple pre-configured network paths between at least two endpoints. A network configuration controller is also provided in communication with the electronically accessible memory and adapted for configuring network communications between the at least two endpoints according to a pre-configured one of the plurality of network paths.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 presents a schematic diagram of an embodiment of a polymorphic network.

FIG. 2 presents a schematic diagram of another embodiment of a polymorphic network having restricted configuration access control.

FIG. 3 shows a flow diagram of an embodiment of a process for establishing secure network connectivity between two nodes.

FIG. 4 shows a flow diagram of an embodiment of a process for adapting network connectivity responsive to perceived malware.

### DESCRIPTION OF THE DISCLOSURE

In the following detailed description of the preferred embodiments, reference is made to accompanying drawings, which form a part thereof, and within which are shown by way of illustration, specific embodiments, by which the invention may be practiced. It is to be understood that other embodiments may be utilized and structural changes may be made without departing from the scope of the invention.

The particulars shown herein are by way of example and for purposes of illustrative discussion of the embodiments of the present disclosure only and are presented in the case of providing what is believed to be the most useful and readily understood description of the principles and conceptual aspects of the present disclosure. In this regard, no attempt is made to show structural details of the present disclosure in more detail than is necessary for the fundamental understanding of the present disclosure, the description taken with the drawings making apparent to those skilled in that how the several forms of the present invention may be embodied in practice. Further, like reference numbers and designations in the various drawings indicate like elements.

In at least some embodiments, the approach described above can be implemented in software. Some of the implementation may require domain knowledge of the network that will be made polymorphic. Even with appropriate domain knowledge, tuning of the network to an application may be required. Although the approaches described herein do not necessarily provide a polymorphic network that can be implemented for all networks, polymorphic assured networks (PAN) will solve problems in important domains, such as networks that control critical infrastructure. Beneficially, PAN is substantially transparent to the users and does not insult important system administrators.

Described herein are embodiments of PAN incorporating aspects described in one or more of U.S. Pat. Nos. 6,532,543; 7,841,009; 7,841,009; and 7,930,761, incorporated herein by reference in their entireties. In at least some embodiments, a polymorphic network has one or more of the following characteristics.

1. In at least some embodiments, a polymorphic network uses a “white list” approach to allow execution only of processes known in advance to be safe. For example, software can be provided that is capable of preparing the white list from a network developed in a trusted environment.

2. For example, when such a polymorphic network is running, unknown processes can be detected by an identifying feature, such as a process ID. Technology implementing such functionality is described, for example, in one or more of the above cited patents. Detecting attacks by assuming that unknown process IDs are attacks can be extremely fast.

3. Using such a white list approach, such systems can be periodically examined to verify some or all executables that are on a disk. In at least some embodiments, and using technology presently available, such a program takes several minutes to execute.

4. When the network detects an unknown process, it will change configuration. Other methods of detecting an attack are allowed for, so that the network changes configuration in response to these attacks as well. However, the unknown process ID detection mechanism implemented detects unknown processes before the process executes and prevents execution. There is therefore time to fail over to another network configuration.

5. In at least some embodiments, the network only changes configuration to alternative configurations that have been previously tested and formally authorized. Formal authorization requires approval from several persons in different chains of command. This presents a defense against rogue insiders.

6. The network can also change configurations simply to confuse an adversary. Again, the change allowed is only to configurations that have been previously tested and formally authorized.

7. PAN technology does not necessarily require a secure processor, although a secure processor would add another layer of security. For example, the secure processor can be implemented by the Secure Processor with Angel Network (SPAN) chip to support the polymorphic network. As used herein, a SPAN chip refers generally to a secure processor chip, with at least some embodiments based on a SiCore SHIELD secure coprocessor board with embedded ANGEL networking technology. Examples of such secure electronic processing modules or chips are described in co-pending patent application, entitled “Secure Processing Module and Method for Making the Same”, Attorney Docket No. BSIL-131US, filed on even date herewith and incorporated herein by reference in its entirety.

PAN is suitable for networks that can know in advance the processes that are allowed. In at least some instances, PAN may not be suitable for a network that must receive communications from sources where it cannot know in advance what the communications will be, since analysis of unknown processes is time consuming. Such an approach may be suitable for the control of networks that manage critical infrastructures.

In at least some embodiments, control mechanisms can be configured to require multiple authorizations to create an alternative network configuration. This feature addresses issues related to defense against insiders. Once such control mechanism, orthogonal authentication, is described in one or more of the patents included herein.

DASH technology: In at least some embodiments, Distributed ANGEL Secure Content Delivery and Host Authentication (DASH) can be used to set up a private network of software agents, which are called ANGELs. ANGELs are described in one or more of the patents that follow. A network of ANGELs is very difficult to reverse engineer. Messages among ANGELs can be encrypted, for example, with keys that have been recently generated and exchanged. In at least some embodiments, such keys can be periodically changed or “strobed.” Using a secure overlay network of ANGELs, one or more of security operations can be conducted, the underlying production network can be examined and polymorphic changes can be applied that network as appropriate.

Ability to change network configurations: In at least some embodiments, a capability to rapidly switch network configurations and to fail over to the new configuration is provided. The term “rapidly” as used herein can imply near real time. Tools such as OSCARs (Open Source Cluster Application Resources) providing software for building high-performance clusters as a scalable means of linking computers together (in an OSCAR model, multiple clients, or compute nodes, run programs in parallel; whereas, a server, or head node, drives the compute nodes, distributing the work to be performed and accumulating the results), and OpenFlow (an open interface for remotely controlling the forwarding tables in network switches, routers, and access points) can be used to facilitate rapid network configurations. At a lower level, GMPLS (Generalized Multi-Protocol Label Switching, to manage further classes of interfaces and switching technologies other than packet interfaces and switching, such as time division multiplex, layer-2 switch, wavelength switch and fiber-switch) and BGP (Border Gateway Protocol (BGP), protocol backing the core routing decisions on the Internet) can be instrumented to permit rapid reconfiguration of network routes. However, many networks set up routes partially or even completely by hand. Reconfiguration often occurs by hand, after human beings have discovered there is a problem. Network administrators are hesitant to permit an instantaneous configuration without the administrator first analyzing the problem and giving his or her approval. In many networks, there is a problem of maintaining state in the new configuration.

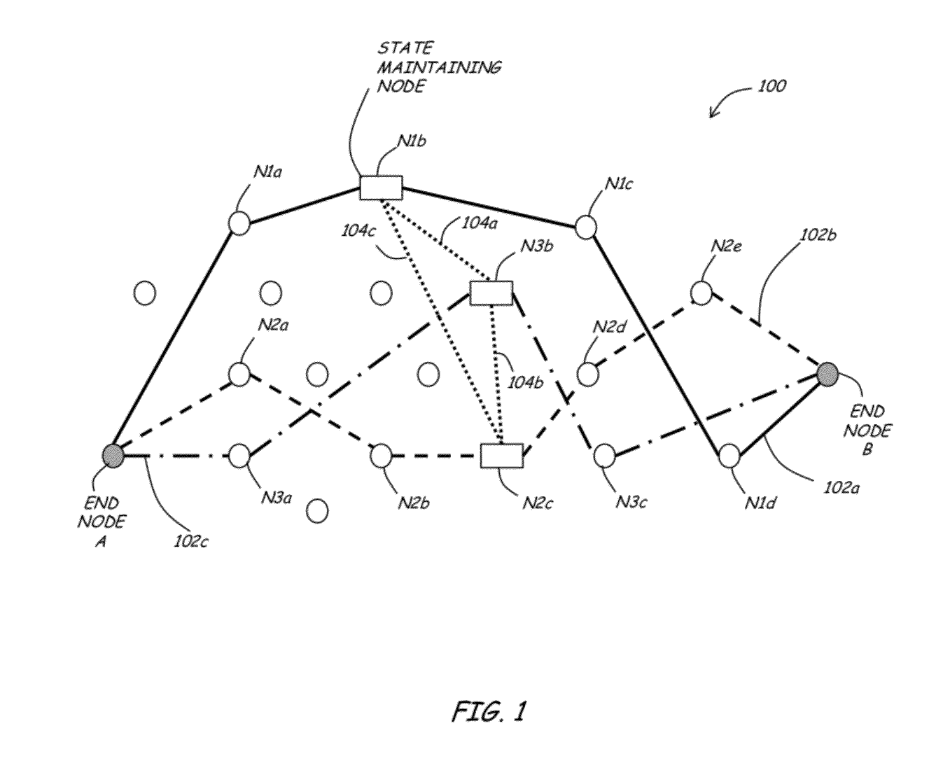

Approaches described herein, which may not be applicable to all networks, define in advance a number of alternative routes, and in at least some instances apply test switching to these routes, otherwise obtaining administrator approval of these routes in advance. FIG. 1 depicts an example of a network topology 100 in which three paths are laid out: a network path 102a, a 1^{st} alternative network path 102b, and a 2^{nd} alternative network path 102c. The paths 102a, 102b, 102c (collectively 102) are completely redundant in the sense that each path 102 uses a different set of intermediate nodes. Namely, the first path 102a comprises End node A, nodes N1a, N1b, N1c, N1d, and end node B. The second path 102b comprises nodes N2a, N2b, N2c, N2d, N2e between the same end nodes. Likewise, the third path 102c, comprises nodes N3a, N3b, N3c between the same end nodes. This is an expensive configuration, but will be used for purposes of illustration. In FIG. 1, the first, second and third paths 102 represent predefined paths. These paths are generally tested frequently. The requirement that reconfiguration occur to confuse an adversary implies that reconfiguration should occur even when there is not an emergency.

Maintenance of State: FIG. 1 depicts special nodes (i.e., nodes N1b, N2c and N3b) that maintain state, distinguished in the illustration as square boxes. In actual networks there may be more than one such node in each path that similarly maintains state. However, just one such node is shown per path for purposes of illustration. The state has to be continuously maintained across all configurations as is shown by the dashed lines 104a, 104b, 104c interconnecting the rectangular boxes. Such dashed lines represent connectivity as may be provided by network connectivity and/or a dedicated connectivity, such as a sideband channel. With such connectivity 104a, 104b, 104c, between state maintaining nodes N1b, N2c, N3b, state can be exchanged from an active path to one or more additional preconfigured paths. In this manner, and with continuous updating, each redundant path will have the state information on hand should a network configuration path change be implemented. Namely, if communications are ongoing along the first path 102a, and state information is being shared with the second and third paths 102b, 102c, then a change in communications path to either of the other paths 102a, 102b can be accomplished without worry as to the loss of state information.

Rules for State Change (i.e., a change from one network path to another): In at least some embodiments, a state change occurs for one or more of the following reasons: (a) periodically to test the network and confuse adversaries; (b) when an attack is sensed on an operating network; and (c) when other nodes sense that the operating path is no longer available. In the illustrative example, one of the nodes, such as End node A manages the path change. End node A depicted in FIG. 1 generally requires rules to perform this task. However, one or more of the paths that the network can change to, the conditions under which the changes will occur, and the methods for executing the changes are controlled against malicious insiders. For example, in some embodiments multiple parties are required to authorized such critical decisions. The use of orthogonal authentication, as described in co-pending provisional patent application filed on even date herewith, entitled “Controlling User Access to Electronic Resources Without Password”, Attorney Docket No. BSIL-132US, and incorporated herein by reference in its entirety, are representative of such methods.

By allowing participation of multiple individuals to set up predefined paths, conditions to invoke the paths, methods for switching the paths, and/or to provide extensive testing of alternative paths when there is not a crisis, PAN offers an environment that will increase the comfort level for administrators to allow instantaneous switching on the network. PAN provides mechanisms to set up and test alternative paths in advance. Which paths are appropriate and how the switching occurs are generally unique to a particular domain. In at least some embodiments for a path switch to occur, state is maintained on the new path. In at least some embodiments, multiple individuals are formally involved in one or more of the path selection, selection of switch conditions, and procedures for implementation of the switch. One path switch trigger may involve appearance of a process on the underlying network which is not on a previously defined white list. A secure method as suggested herein can be used to obtain approval that will defend against malicious insiders without insulting individuals.

Such a polymorphic assured network (PAN) can rapidly switch between pre-tested paths. Square boxes shown in FIG. 1 contain state, which can be continuously updated. Nodes can be configured to run DASH software, which provides secure private network and monitors network state. To defend against malicious insiders, decisions such as path approval and switching criteria require multiple approvals. By using specialized software agents (ANGELs) there is no need to rely on passwords to enforce approval.

Approaches for polymorphic networks, such as those described herein, preferably offer substantial controls against insider malfeasance and near real time switching response. Such approaches are suitable for critical network where tasks are predefined, such as power grid. Such approaches can be strengthened using SPAN chip technology, as described in co-pending provisional patent application filed on even date herewith and entitled “Secure Processor With Angel Network (SPAN) Chip.”

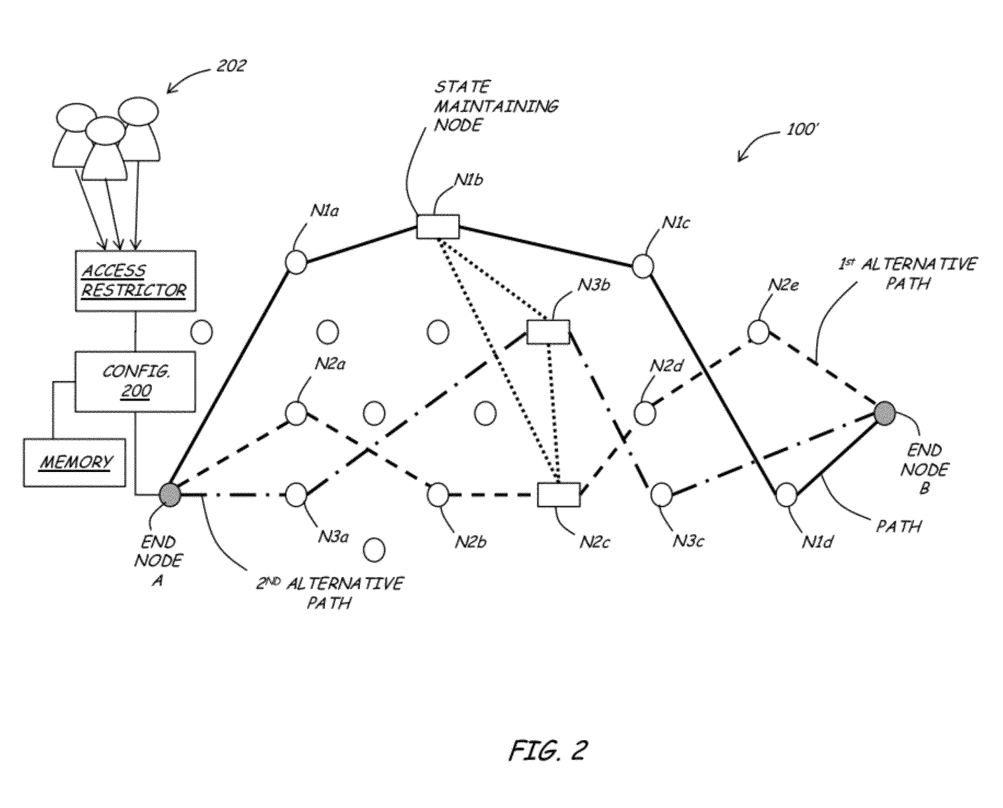

FIG. 2 presents a schematic diagram of another embodiment of a polymorphic network having restricted configuration access control. Again, considering that End node A manages the path change. A configuration control application 200 is provided in communication with End node A. In at least some embodiments, an electronically accessible memory is also provided in communication with the configuration application for among other things storing at least the pre-configured network paths. One or more users 202 can access the configuration control application 200 to one or more of pre-configure preferred network configuration paths and to implement or otherwise establish one or more rules governing state change between various pre-configured network paths. In order to prevent unauthorized access, at least some level of access restriction 204 is provided between the users 202 and the configuration application 200. For example, the access restriction can include implementation of one or more of the DASH technology and ANGELs for establishing secure communications described herein.

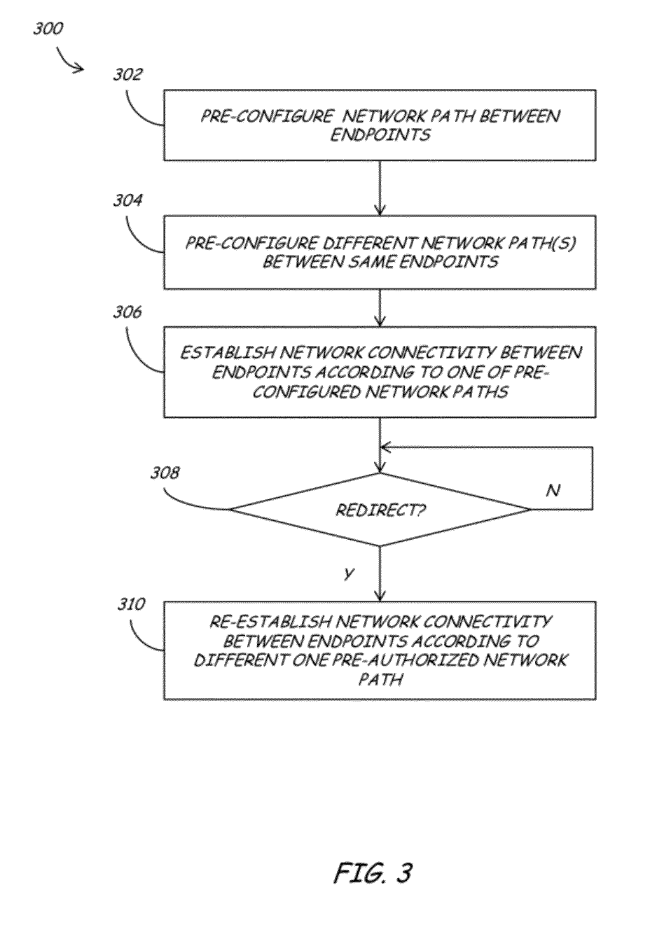

FIG. 3 shows a flow diagram of an embodiment of a process 300 for establishing secure network connectivity between two nodes. A network path is pre-configured between endpoints at 302. One or more different network path(s) are similarly pre-configure between same endpoints at 304. Network connectivity is established between endpoints according to one of pre-configured network paths at 306. A determination is made at 308 as to whether the network path should be redirected. In response to a determination that reconfiguration is necessary, network connectivity is re-established between endpoints according to different one of the one or more pre-authorized network paths at 310.

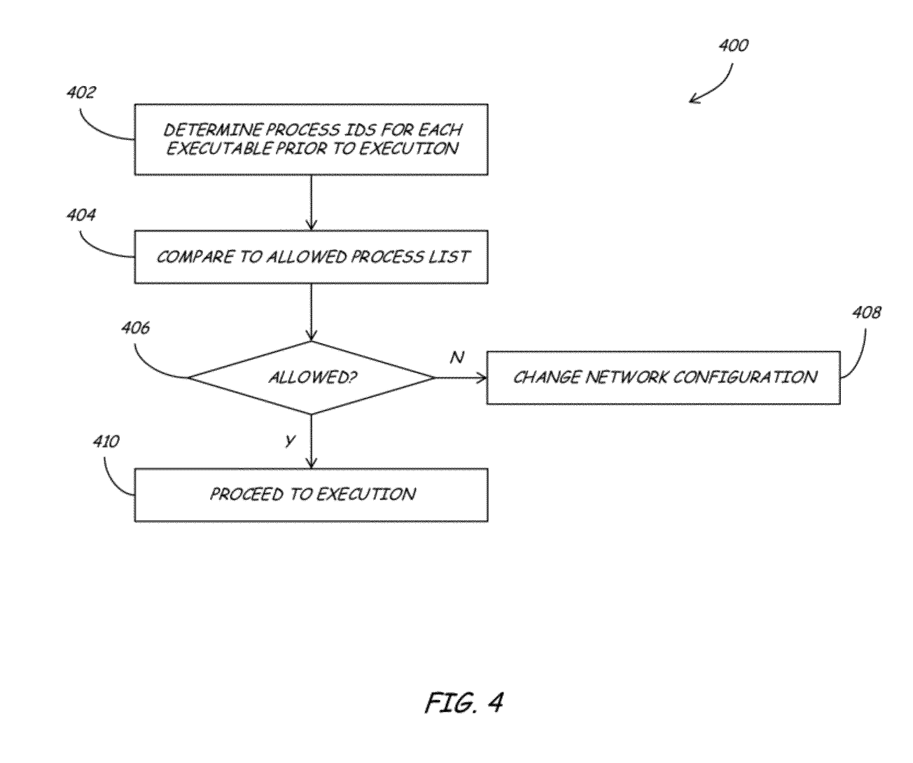

FIG. 4 shows a flow diagram of an embodiment of a process for adapting network connectivity responsive to perceived malware. Process IDs are determined for each executable prior to execution at 402. A comparison of the determined process IDs to allowed process list (e.g., “white list”) is accomplished at 404. In response to a determination from the comparison at 406 that the process associated with the determined process ID is not allowed, change the network configuration at 408. Otherwise, proceed to execution at 410.

Performance improvements realized by the techniques described herein can support one or more of: (1) near real-time path switching; (2) maintaining state on switched paths; (3) switching to confuse attackers & appearance of unknown process among other events; and (4) controlling switch setup to defend against malicious insiders.

Performance for key parameters can include one or more of: switching speeds within about two seconds; the realization that no unknown processes will execute; and at least two unrelated approvals required for switch operations.

Whereas many alterations and modifications of the present disclosure will no doubt become apparent to a person of ordinary skill in the art after having read the foregoing description, it is to be understood that the particular embodiments shown and described by way of illustration are in no way intended to be considered limiting. Further, the invention has been described with reference to particular preferred embodiments, but variations within the spirit and scope of the invention will occur to those skilled in the art. It is noted that the foregoing examples have been provided merely for the purpose of explanation and are in no way to be construed as limiting of the present disclosure.

While the present disclosure has been described with reference to example embodiments, it is understood that the words, which have been used herein, are words of description and illustration, rather than words of limitation. Changes may be made, within the purview of the appended claims, as presently stated and as amended, without departing from the scope and spirit of the present disclosure in its aspects.

Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

We claim:

1. A method for networked communications comprising:
pre-configuring a network communications path between two endpoints, the network communications path being suitable for communications between the two endpoints;
pre-configuring at least one different network communications path between the two endpoints, each of the at least one different network communication paths being suitable for communications between the two endpoints; and
periodically redirecting communications between the two endpoints from one of the network communications path and the at least one different network communications path to another of the network communications path and the at least one different network communications path.

2. The method of claim 1, wherein each of the network communications path and the at least one different network communications path is selected from a plurality of pre-authorized network communications paths.

3. The method of claim 2, wherein generation of pre-authorized network communications paths comprises subjecting such network communications paths responsive to an authorization control feature.

4. The method of claim 3, wherein the authorization control feature comprises orthogonal authentication.

5. The method of claim 1, wherein the network communications path and the at least one different network communications path provide redundant network communications paths between the two endpoints.

6. The method of claim 5, wherein the redundant network communications paths between the two endpoints encompass different intermediate network communications nodes.

7. The method of claim 5, wherein at least one network communications node in each of the network communications path and the at least one different network communications path between the two endpoints comprises a respective state-maintaining node adapted to maintain state information for an active one of the network communications path and the at least one different network communications path.

8. The method of claim 7, wherein state information is substantially continuously updated on more than one of the network communications path and the at least one different network communications path.

9. The method of claim 1, wherein the act of redirecting communications comprises:
detecting appearance of a non pre-authorized process; and
redirecting communications between the two endpoints from one of the network communications path and the at least one different network communications path to another of the network communications path and the at least one different network communications path responsive to detecting appearance of a non-pre-authorized process.

10. A network control system, comprising:
a network pre-configuration controller in communication with a communications network and adapted to permit pre-configuration of a plurality of network paths between at least two endpoints;
an access restrictor in communication with the network configuration controller and adapted to prohibit unauthorized pre-configuration of the plurality of network paths;
an electronically accessible memory in communication with the network configuration controller storing the plurality of pre-configured network paths between at least two endpoints; and
a network configuration controller in communication with the electronically accessible memory and adapted for configuring network communications between the at least two endpoints according to a pre-configured one of the plurality of network paths.

11. The network control system of claim 10, wherein at least one of the network pre-configuration controller and the network configuration controller comprises a secure processor.

12. The network control system of claim 10, wherein at least one of the network pre-configuration controller and the network configuration controller is collocated with one of the at least two endpoints.

13. The network control system of claim 10, further comprising at least one respective state-maintaining node for each network path of the pre-configured plurality of network paths.

14. The network control system of claim 13, further comprising communications path between each of the at least one respective state-maintaining nodes of each network path of the pre-configured plurality of network paths, whereby each of the at least one respective state-maintaining nodes comprises state information corresponding to an active network path of the pre-configured plurality of network paths.

15. The network control system of claim 10, wherein the network pre-configuration controller comprises the network configuration controller.

16. The network control system of claim 10, wherein the access restrictor comprises means for orthogonal authentication.
